(19) United States
(12) Patent Application Publication
(10) Pub. No.: US 2010/0208399 A1
(43) Pub. Date: Aug. 19, 2010

(54) ELECTROSTATIC DISCHARGE PROTECTION CIRCUIT

(76) Inventors: Jing-Chi Yu, Hsinchu City (TW); Hsiao-Ling Chen, Hsinchu County (TW); Yu-Lun Lu, Yilan County (TW); Chang-Chih Hsieh, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/421,583

(22) Filed: Apr. 9, 2009

(30) Foreign Application Priority Data
Feb. 17, 2009 (TW) 098104948

(51) Int. Cl. H02H 9/00

(52) U.S. Cl. 361/56

(57) ABSTRACT

An electrostatic discharge protection circuit includes: an electrostatic protection device coupled between a first reference voltage terminal and a signal pad for protecting a circuit coupled to the signal pad; a bipolar junction transistor including an emitter terminal coupled to the signal pad, a collector terminal coupled to a second reference voltage terminal, and a base terminal coupled to the first reference voltage terminal, wherein the bipolar junction transistor is a parasitic bipolar junction transistor of the electrostatic protection device; and a clamping circuit coupled to the bipolar junction transistor for clamping a conductivity of the bipolar junction transistor according to a signal received at the signal pad.

### BACKGROUND OF THE INVENTION

1. Field of the Invention

The present invention relates to an electrostatic discharge protection circuit of an input/output interface, and more particularly, to an electrostatic discharge protection circuit for improving the current leakage of a parasitic bipolar junction transistor.

2. Description of the Prior Art

In a circuit system, the communications between the chips are achieved via an input/output interface. The signal of the input/output interface transmitted between the chips commonly has a regular form. That is, the voltage and frequency of the signal are usually set at a suitable range. However, the shape of the transmission signal has the phenomenon of overshoot, undershoot or jitter due to the problems of impedance mismatch, coupling effect between the transmission lines and noise interference when the signal is transmitted via the transmission line connected between the chips. The above-mentioned phenomenon may cause a current leakage scenario at the input/output interface, resulting in a voltage level shift of the well or the substrate belonging to the input/output interface chip.

Please refer to FIG. 1 in conjunction with FIG. 2. FIG. 1 is a high voltage process cross-sectional diagram illustrating a prior art electrostatic protection device 10 implemented by metal oxide semiconductor field-effect transistors (MOSFETs). The high voltage process includes a P-substrate 12, a first N-well 14, a second N-well 16 and a P-well 18. FIG. 2 is a diagram illustrating an equivalent protection circuit 20 of the electrostatic protection device 10 shown in FIG. 1. The electrostatic protection device 10 is used for protecting an internal circuit (not shown) connected to a signal pad 22. The equivalent protection circuit 20 includes a P-type field effect transistor (PFET) M1, an N-type field effect transistor (NFET) M2, a P-type parasitic bipolar junction transistor M3 and an N-type parasitic bipolar junction transistor M4. As shown in FIG. 1, the PFET M1 is implemented on the second N-well 16, and the NFET M2 is implemented on the second P-well 18. The cascade of the P-substrate 12, the first N-well 14, the second N-well 16 and a P-type doping region 162 will generate the P-type parasitic bipolar junction transistor M3, and the cascade of the first N-well 14, the P-well 18 and an N-type doping region 182 will generate the N-type parasitic bipolar junction transistor M4 in the high voltage process. The P-substrate 12 is electrically connected to a first voltage level VSS2 via a P-type doping region 122, the P-type parasitic bipolar junction transistor M3 has an emitter coupled to the signal pad 22 via the P-type doping region 162 (i.e. the drain terminal of the PFET M1), a base electrically connected to a second voltage level VCC1 via the N-type doping region 164 (i.e. the bulk terminal of the PFET M1), and a collector electrically connected to the first voltage level VSS2 via the P-type doping region 122. The N-type parasitic bipolar junction transistor M4 has an emitter coupled to the signal pad 22 via the N-type doping region 182 (i.e. the drain terminal of the NFET M2), a base electrically connected to a third voltage level VSS1 via a P-type doping region 184 (i.e. the bulk terminal of the NFET M2), and a collector electrically connected to the second voltage level VCC1 via an N-type doping region 142.

If an overshoot portion 24 of an input signal Sin exceeds the second voltage level VCC1 and the potential difference between the overshoot portion 24 and the second voltage level VCC1 is larger than a threshold voltage Vth of a junction diode when the input signal Sin is received at the signal pad 22, the P-type parasitic bipolar junction transistor M3 will be turned on. The current generated by the overshoot portion 24 will flow from the emitter of the P-type parasitic bipolar junction transistor M3 to the collector of the P-type parasitic bipolar junction transistor M3 when the P-type parasitic bipolar junction transistor M3 is turned on. Thus, the first voltage level VSS2 of the P-substrate 12 may be boosted to lose its accuracy. On the other hand, if an undershoot portion 26 of the input signal Sin is lower than the third voltage level VSS1 and the potential difference between the undershoot portion 26 and the third voltage level VSS1 is larger than the threshold voltage Vth of the junction diode, the N-type parasitic bipolar junction transistor M4 will be turned on. The current generated by the undershoot portion 26 will flow from the collector of the N-type parasitic bipolar junction transistor M4 to the emitter of the N-type parasitic bipolar junction transistor M4 when the N-type parasitic bipolar junction transistor M4 is turned on. Thus, the second voltage level VCC1 of the first N-well 14 may be lowered to lose its accuracy.

Similarly, when the high voltage process is utilized for realizing an electrostatic protection device implemented by the diodes, two parasitic bipolar junction transistors will be generated, as shown in FIG. 3. FIG. 3 is a high voltage process cross-sectional diagram illustrating a prior art electrostatic protection device 30 implemented by the diodes. Similar to FIG. 1, the high voltage process includes a P-substrate 32, a first N-well 34, a second N-well 36 and a P-well 38. FIG. 4 is a diagram illustrating an equivalent protection circuit 40 of the electrostatic protection device 30 shown in FIG. 3. The electrostatic protection device 30 is used for protecting an internal circuit (not shown) connected to a signal pad 42. The equivalent protection circuit 40 includes a first diode D1, a second diode D2, a P-type parasitic bipolar junction transistor M5 and an N-type parasitic bipolar junction transistor M6. According to FIG. 3, the first diode D1 is implemented on the second N-well 36, and the second diode D2 is implemented on the second P-well 38. Similarly, the cascade of the P-substrate 32, the first N-well 34, the second N-well 36 and a P-type doping region 362 will form the P-type parasitic bipolar junction transistor M5, and the cascade of the first N-well 34, the P-well 38 and a N-type doping region 382 will form the N-type parasitic bipolar junction transistor M6. The P-substrate 32 is electrically connected to a first voltage level VSS2 via a P-type doping region 322. The P-type parasitic bipolar junction transistor M5 has an emitter coupled to the signal pad 42 via the P-type doping region 362 (i.e. the anode of the first diode D1), a base electrically connected to a second voltage level VCC1 via the N-type doping region 364 (i.e. the cathode of the first diode D1), and a collector electrically connected to the first voltage level VSS2 via the P-type doping region 322. The N-type parasitic bipolar junction transistor M6 has an emitter coupled to the signal pad 42 via the N-type doping region 382 (i.e. the cathode of the second diode D2), a base electrically connected to a third voltage level VSS1 via a P-type doping region 384 (i.e. the anode of the second diode D2), and a collector electrically connected to the second voltage level VCC1 via a N-type doping region 342.

If an overshoot portion 44 of an input signal Sin exceeds the second voltage level VCC1 and the potential difference between the overshoot portion 44 and the second voltage level VCC1 is larger than a threshold voltage Vth of a junction diode when the input signal Sin is received at the signal pad 42, the P-type parasitic bipolar junction transistor M5 will be turned on. The current generated by the overshoot portion 44 will flow from the emitter of the P-type parasitic bipolar junction transistor M5 to the collector of the P-type parasitic bipolar junction transistor M5 when the P-type parasitic bipolar junction transistor M5 is turned on. Thus, the first voltage level VSS2 of the P-substrate 32 may be boosted to lose its accuracy. On the other hand, if an undershoot portion 46 of the input signal Sin is lower than the third voltage level VSS1 and the potential difference between the undershoot portion 46 and the third voltage level VSS1 is larger than the threshold voltage Vth of the junction diode, the N-type parasitic bipolar junction transistor M6 will be turned on. The current generated by the undershoot portion 46 will flow from the collector of the N-type parasitic bipolar junction transistor M6 to the emitter of the N-type parasitic bipolar junction transistor M6 when the N-type parasitic bipolar junction transistor M6 is turned on. Thus, the second voltage level VCC1 of the first N-well 34 may be lowered to lose its accuracy.

Therefore, how to reduce the current leakage of the electrostatic protection device implemented in the input/output interface is an urgent issue for designers in the high voltage process field.

### SUMMARY OF THE INVENTION

Therefore, one of the objectives of the present invention is to provide an electrostatic discharge protection circuit for decreasing the current leakage of a parasitic bipolar junction transistor.

According to an embodiment of the present invention, an electrostatic discharge protection circuit is disclosed. The electrostatic discharge protection circuit comprises an electrostatic protection device, a bipolar junction transistor and a clamping circuit. The electrostatic protection device is coupled between a first reference voltage terminal and a signal pad for protecting a circuit coupled to the signal pad. The bipolar junction transistor has an emitter terminal coupled to the signal pad, a collector terminal coupled to a second reference voltage terminal, and a base terminal coupled to the first reference voltage terminal, wherein the bipolar junction transistor is a parasitic bipolar junction transistor of the electrostatic protection device. The clamping circuit is coupled to the bipolar junction transistor for clamping a conductivity of the bipolar junction transistor according to a signal received at the signal pad.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a high voltage process cross-sectional diagram illustrating a prior art electrostatic protection device implemented by MOSFETs.

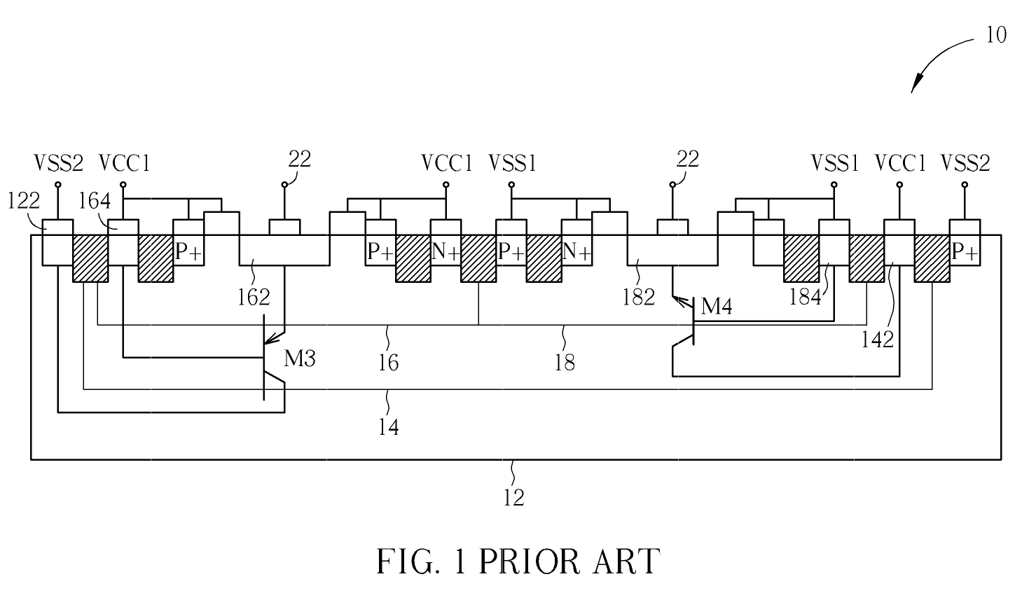

FIG. 2 is a diagram illustrating an equivalent protection circuit of the electrostatic protection device shown in FIG. 1.

FIG. 3 is a high voltage process cross-sectional diagram illustrating a prior art electrostatic protection device implemented by diodes.

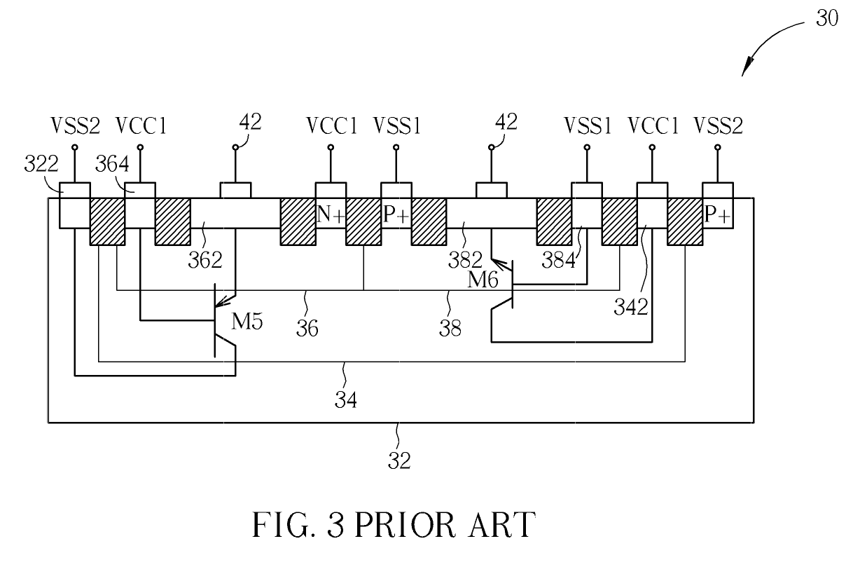

FIG. 4 is a diagram illustrating an equivalent protection circuit of the electrostatic protection device shown in FIG. 3.

FIG. 5 is a diagram illustrating an electrostatic discharge protection circuit according to an embodiment of the present invention.

FIG. 6 is a diagram illustrating an electrostatic discharge protection circuit according to another embodiment of the present invention.

FIG. 7 is a diagram illustrating an electrostatic discharge protection circuit according to yet another embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

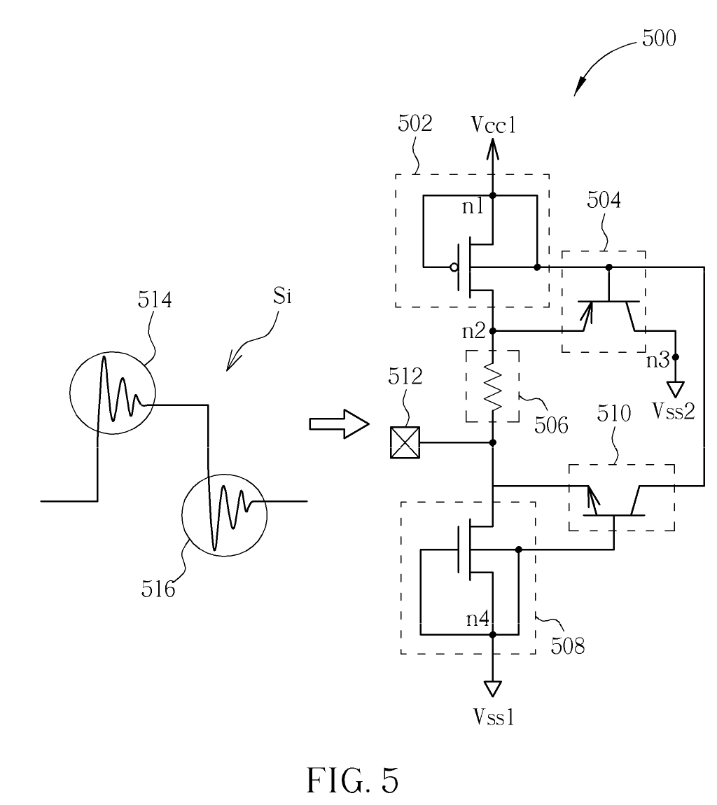

Please refer to FIG. 5. FIG. 5 is a diagram illustrating an electrostatic discharge protection circuit according to an exemplary embodiment of the present invention. The electrostatic discharge protection circuit 500 includes, but is not limited to, a first electrostatic protection device 502, a first bipolar junction transistor 504, a clamping circuit 506, a second electrostatic protection device 508, and a second bipolar junction transistor 510. The first electrostatic protection device 502 is coupled between a first reference voltage terminal n1 and a terminal n2 for protecting a circuit (not shown) coupled to a signal pad 512. The first bipolar junction transistor 504 has an emitter terminal coupled to the terminal n2, a base terminal coupled to the first reference voltage terminal n1, and a collector terminal coupled to the second reference voltage terminal n3. The clamping circuit 506 includes a first terminal electrically connected to the terminal n2 and a second terminal electrically connected to the signal pad 512, and is implemented for clamping a conductivity of the first bipolar junction transistor 504 according to a signal Si received at the signal pad 512. In this embodiment, the signal Si is not an electro-discharge signal. The second electrostatic protection device 508 coupled between a third reference voltage terminal n4 and the signal pad 512, for protecting the circuit coupled to the signal pad 512. The second bipolar junction transistor 510 has an emitter terminal coupled to the signal pad 512, a base terminal coupled to the second reference voltage terminal n3, and a collector terminal coupled to the first reference voltage terminal n1.

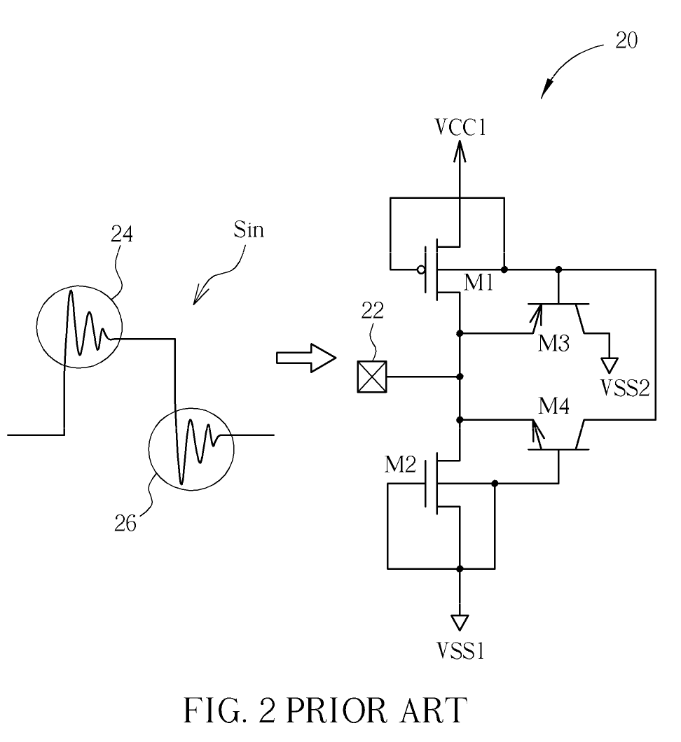

Please note that the first electrostatic protection device 502 of this exemplary embodiment is a P-type field effect transistor fabricated by a high voltage process, and has a gate terminal, a source terminal and a bulk terminal all coupled to the first reference voltage terminal n1, and a drain terminal coupled to the terminal n2; the second electrostatic protection device 508 is an N-type field effect transistor fabricated by the high voltage process, which has a gate terminal, a source terminal and a bulk terminal all coupled to the third reference voltage terminal n4, and a drain terminal coupled to the signal pad 512. Therefore, the first bipolar junction transistor 504 is a parasitic bipolar junction transistor formed due to using the high voltage process to fabricate the P-type field effect transistor, and the second bipolar junction transistor 510 is a parasitic bipolar junction transistor formed due to using the high voltage process to fabricate the N-type field effect transistor. When the electrostatic discharge protection circuit 500 operates in a normal operating mode, the first reference voltage terminal n1 is electrically connected to a first reference voltage level Vcc1, the second reference voltage terminal n3 is electrically connected to a second reference voltage level Vss2, and the third reference voltage terminal n4 is electrically connected to a third reference voltage level Vss1. In this embodiment, the electrostatic discharge protection circuit 500 can be fabricated by a prior art high voltage process shown in FIG. 2.

The clamping circuit 506 is implemented by a resistor device in this embodiment; however, this is not meant to be a limitation of the present invention. The clamping circuit 506 coupled between the first electrostatic protection device 502 and the signal pad 512 will provide a voltage drop between the first electrostatic protection device 502 and the signal pad 512 when the signal pad 512 receives the signal Si having the overshoot phenomenon (i.e. the overshoot portion 514) and the undershoot phenomenon (i.e. the undershoot portion 516), and the voltage level of the overshoot portion 514 is higher than the first reference voltage level Vcc1. Thus, the potential difference between the emitter terminal (i.e. the terminal n2) and the base terminal (i.e. the terminal n1) of the first bipolar junction transistor 504 will be reduced due to the voltage drop. This will reduce the conductivity of the first bipolar junction transistor 504 or even turn off the first bipolar junction transistor 504. Accordingly, the clamping circuit 506 will partially reduce or completely stop the current flowing from the signal pad 512 to the second reference voltage terminal n3. As a result, the accuracy of the second reference voltage level Vss2 is enhanced.

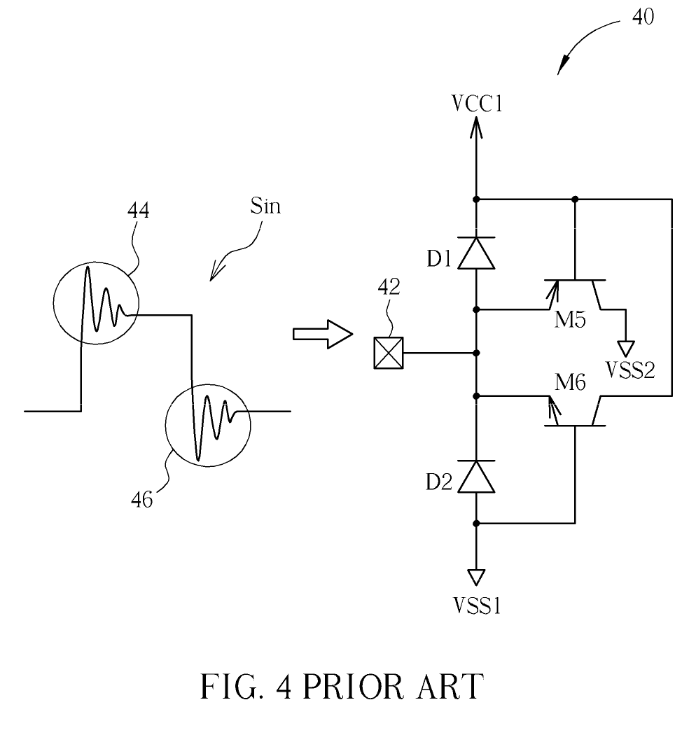

Please note that coupling the clamping circuit 506 between the first electrostatic protection device 502 and the signal pad 512 is not meant to be a limitation of the present invention. According to another embodiment of the present invention, the clamping circuit 506 is coupled between the second electrostatic protection device 508 and the signal pad 512, for reducing the conductivity of the second bipolar junction transistor 510 or even turning off the second bipolar junction transistor 510 when the voltage level of the undershoot portion 516 is lower than the third reference voltage level Vss1, thereby enhancing the accuracy of the first reference voltage level Vcc1. Implementing the P-type field effect transistor and the N-type field effect transistor as, respectively, the first electrostatic protection device 502 and the second electrostatic protection device 508 is not meant to be a limitation in this embodiment. According to yet another embodiment of the present invention, the first electrostatic protection device 502 and the second electrostatic protection device 508 are implemented by diodes, as shown in FIG. 4. As a person skilled in the art can readily understand the related operation of such an alternative design after reading the above paragraphs directed to technical features of the embodiment shown in FIG. 5, further description is omitted here for brevity.

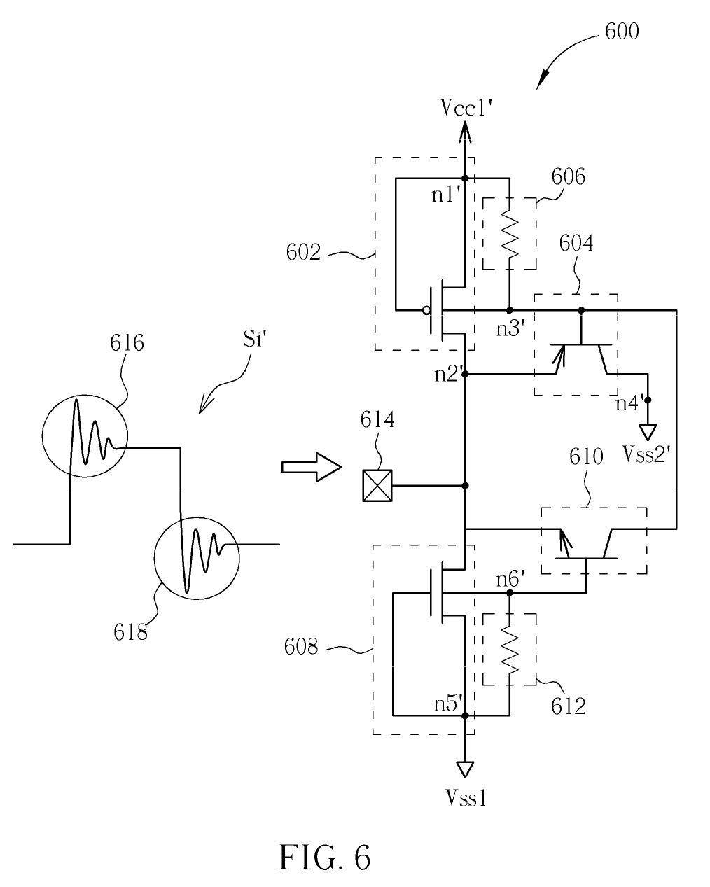

Please refer to FIG. 6. FIG. 6 is a diagram illustrating an electrostatic discharge protection circuit according to another exemplary embodiment of the present invention. The electrostatic discharge protection circuit 600 includes, but is not limited to, a first electrostatic protection device 602, a first bipolar junction transistor 604, a first clamping circuit 606, a second electrostatic protection device 608, a second bipolar junction transistor 610, and a second clamping circuit 612. The first electrostatic protection device 602 is coupled between a first reference voltage terminal n1′ and a terminal n2′ for protecting a circuit (not shown) coupled to a signal pad 614. The first bipolar junction transistor 604 has an emitter terminal coupled to the terminal n2′, a base terminal coupled to a terminal n3′, and a collector terminal coupled to a second reference voltage terminal n4′. The first clamping circuit 606 includes a first terminal electrically connected to the terminal n3′ and a second terminal electrically connected to the first reference voltage terminal n1′, and is implemented for clamping a conductivity of the first bipolar junction transistor 604 according to a signal Si′ received at the signal pad 614. In this embodiment, the signal Si′ is not an electro-discharge signal. The second electrostatic protection device 608 is coupled between a third reference voltage terminal n5′ and the terminal n2′, for protecting the circuit coupled to the signal pad 614. The second bipolar junction transistor 610 has an emitter terminal coupled to the terminal n2′, a base terminal coupled to a terminal n6′, and a collector terminal coupled to the terminal n3′. The second clamping circuit 612 includes a first terminal electrically connected to the terminal n6′ and a second terminal electrically connected to the third reference voltage terminal n5′, and is implemented for clamping a conductivity of the second bipolar junction transistor 610 according to a signal Si′ received at the signal pad 614.

Please note that the first electrostatic protection device 602 of this embodiment is a P-type field effect transistor fabricated by a high voltage process, and has a gate terminal and a source terminal both coupled to the first reference voltage terminal n1′, a bulk terminal coupled to the terminal n3′, and a drain terminal coupled to the terminal n2′; the second electrostatic protection device 608 is an N-type field effect transistor fabricated by the high voltage process, and has a gate terminal and a source terminal both coupled to the third reference voltage terminal n5′, a bulk terminal coupled to the terminal n6′, and a drain terminal coupled to the terminal n2′. Therefore, the first bipolar junction transistor 604 is a parasitic bipolar junction transistor formed due to using the high voltage process to fabricate the P-type field effect transistor, and the second bipolar junction transistor 610 is a parasitic bipolar junction transistor formed due to using the high voltage process to fabricate the N-type field effect transistor. When the electrostatic discharge protection circuit 600 operates in a normal operating mode, the first reference voltage terminal n1′ is electrically connected to a first reference voltage level Vcc1+, the second reference voltage terminal n4′ is electrically connected to a second reference voltage level Vss2′, and the third reference voltage terminal n5′ is electrically connected to a third reference voltage level Vss1′. In this embodiment, the electrostatic discharge protection circuit 600 can be fabricated by the prior art high voltage process shown in FIG. 2.

The first clamping circuit 606 and the second clamping circuit 612 are implemented by resistor devices in this embodiment; however, this is not meant to be a limitation of the present invention. The clamping circuit 606 coupled between the first reference voltage terminal n1′ and the terminal n3′ will provide a voltage drop between the first reference voltage terminal n1′ and the terminal n3′ when the signal pad 614 receives the signal Si′ having the overshoot phenomenon (i.e. the overshoot portion 616) and the undershoot phenomenon (i.e. the undershoot portion 618), and the voltage level of the overshoot portion 616 is higher than the first reference voltage level Vcc1′. Thus, the potential difference between the emitter terminal (i.e. the terminal n2′) and the base terminal (i.e. the terminal n3′) of the first bipolar junction transistor 604 will be reduced due to the voltage drop. This will reduce the base current of the first bipolar junction transistor 604 or even reduce the base current of the first bipolar junction transistor 604 to zero. Therefore, the clamping circuit 606 will partially reduce or completely stop the current flowing from the signal pad 614 to the second reference voltage terminal n4′, thereby enhancing the accuracy of the second reference voltage level Vss2′.

The clamping circuit 612 coupled between the third reference voltage terminal n5′ and the terminal n6′ will provide a voltage drop between the third reference voltage terminal n5′ and the terminal n6′ when the voltage level of the undershoot portion 618 of the signal Si′ is lower than the third reference voltage level Vss1′. Thus, the potential difference between the emitter terminal (i.e. the terminal n2′) and the base terminal (i.e. the terminal n6′) of the second bipolar junction transistor 610 will be reduced due to the voltage drop. This will reduce the base current of the second bipolar junction transistor 610 or even reduce the base current of the second bipolar junction transistor 610 to zero. Therefore, the clamping circuit 612 will partially reduce or completely stop the current flowing from the first reference voltage terminal n1′ to the signal pad 614, thereby enhancing the accuracy of the first reference voltage level Vcc1′.

Similarly, implementing the P-type field effect transistor and the N-type field effect transistor respectively as the first electrostatic protection device 602 and the second electrostatic protection device 608 is also not a limitation of this embodiment. According to another embodiment of the present invention, the first electrostatic protection device 602 and the second electrostatic protection device 608 can be implemented by diodes, as shown in FIG. 4. As a person skilled in the art can readily understand the related operation of such an alternative design after reading the above paragraphs directed to technical features of the embodiment shown in FIG. 6, further description is omitted here for brevity.

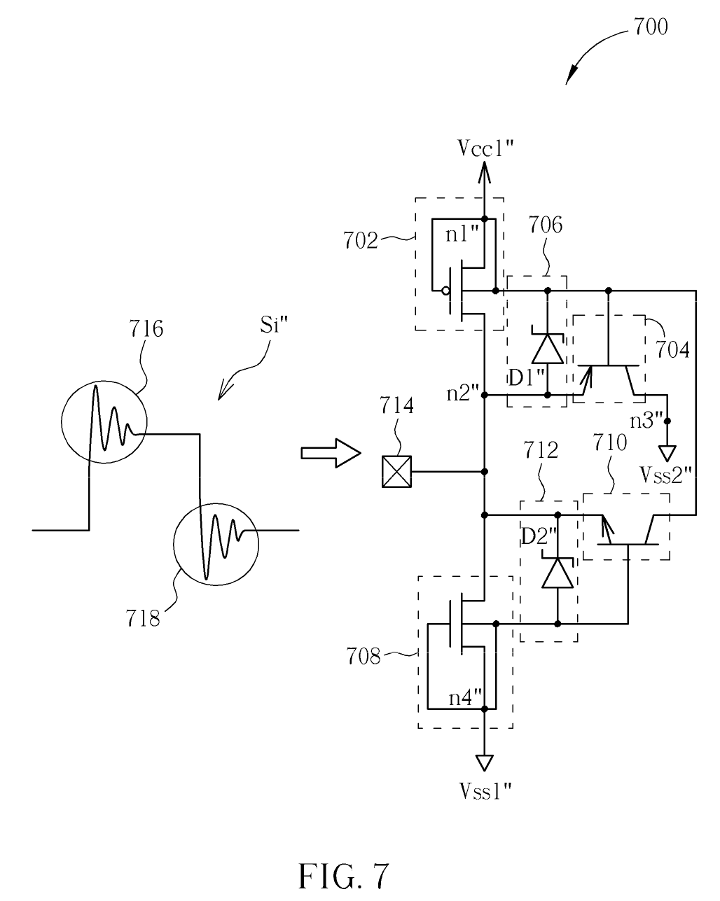

Please refer to FIG. 7. FIG. 7 is a diagram illustrating an electrostatic discharge protection circuit according to yet another embodiment of the present invention. The electrostatic discharge protection circuit 700 includes, but is not limited to, a first electrostatic protection device 702, a first bipolar junction transistor 704, a first clamping circuit 706, a second electrostatic protection device 708, a second bipolar junction transistor 710, and a second clamping circuit 712. The first electrostatic protection device 702 is coupled between a first reference voltage terminal n1″ and a terminal n2″ for protecting a circuit (not shown) coupled to a signal pad 714. The first bipolar junction transistor 704 has an emitter terminal coupled to the terminal n2″, a base terminal coupled to a first reference voltage terminal n1″, and a collector terminal coupled to a second reference voltage terminal n3″. The first clamping circuit 706 includes a first terminal electrically connected to the terminal n2″ and a second terminal electrically connected to the first reference voltage terminal n1″, for clamping a conductivity of the first bipolar junction transistor 704 according to a signal Si″ received at the signal pad 714. In this embodiment, the signal Si″ is not an electro-discharge signal. The second electrostatic protection device 708 is coupled between a third reference voltage terminal n4″ and the terminal n2″, for protecting the circuit coupled to the signal pad 714. The second bipolar junction transistor 710 has an emitter terminal coupled to the terminal n2″, a base terminal coupled to the third reference voltage terminal n4″, and a collector terminal coupled to the first reference voltage terminal n1″. The second clamping circuit 712 includes a first terminal electrically connected to the terminal n2″ and a second terminal electrically connected to the third reference voltage terminal n4″, for clamping a conductivity of the second bipolar junction transistor 710 according to a signal Si″ received at the signal pad 714.

Please note that, the first electrostatic protection device 702 of this embodiment is a P-type field effect transistor fabricated by a high voltage process, and has a gate terminal, a bulk terminal and a source terminal all coupled to the first reference voltage terminal n1″, and a drain terminal coupled to the terminal n2″; the second electrostatic protection device 708 is an N-type field effect transistor fabricated by the high voltage process, and has a gate terminal, a bulk terminal and a source terminal all coupled to the third reference voltage terminal n4″, and a drain terminal coupled to the terminal n2Δ. Therefore, the first bipolar junction transistor 704 is a parasitic bipolar junction transistor formed due to using the high voltage process to fabricate the P-type field effect transistor, and the second bipolar junction transistor 710 is a parasitic bipolar junction transistor formed due to using the high voltage process to fabricate the N-type field effect transistor. When the electrostatic discharge protection circuit 700 operates in a normal operating mode, the first reference voltage terminal n1″ is electrically connected to a first reference voltage level Vcc1″, the second reference voltage terminal n3″ is electrically connected to a second reference voltage level Vss2″, and the third reference voltage terminal n4″ is electrically connected to a third reference voltage level Vss1″. In this embodiment, the electrostatic discharge protection circuit 700 can be fabricated by the prior art high voltage process shown in FIG. 2.

The first clamping circuit 706 and the second clamping circuit 712 are implemented by schottky diodes D1″ and D2″ in this embodiment, wherein the schottky diode D1″ has an anode electrically connected to the terminal n2″, and a cathode electrically connected to the first reference voltage terminal n1″, and the other schottky diode D2″ has an anode electrically connected to the third reference voltage terminal n4″, and a cathode electrically connected to the terminal n2″. Therefore, the schottky diode D1″ coupled between the first reference voltage terminal n1″ and the terminal n2″ will be turned on to provide a voltage drop between the first reference voltage terminal n1″ and the terminal n2″ when the signal pad 714 receives the signal Si″ having the overshoot phenomenon (i.e. the overshoot portion 716) and the undershoot phenomenon (i.e. the undershoot portion 718), and the voltage level of the overshoot portion 716 is higher than the first reference voltage level Vcc1″. In addition, the voltage drop is smaller than the threshold voltage Vth of the junction diode. Thus, the potential difference between the emitter terminal (i.e. the terminal n2″) and the base terminal (i.e. the first reference voltage terminal n1″) of the first bipolar junction transistor 704 will be smaller than the threshold voltage Vth of the first bipolar junction transistor 704. As a result, the first bipolar junction transistor 704 will be turned off. The clamping circuit 706 therefore partially reduces or completely stops the current flowing from the signal pad 714 to the second reference voltage terminal n3″, thereby enhancing the accuracy of the second reference voltage level Vss2″.

The schottky diode D2″ coupled between the third reference voltage terminal n4″ and the terminal n2″ will provide a voltage drop between the third reference voltage terminal n4″ and the terminal n2″ when the voltage level of the undershoot portion 718 of the signal Si″ is lower than the third reference voltage level Vss1″. The voltage drop is smaller than the threshold voltage Vth of the junction diode. Thus, the potential difference between the emitter terminal (i.e. the terminal n2″) and the base terminal (i.e. the third reference voltage terminal n4″) of the second bipolar junction transistor 710 will be smaller than the threshold voltage Vth of the second bipolar junction transistor 710. As a result, the second bipolar junction transistor 710 will be turned off. The clamping circuit 712 therefore partially reduces or completely stops the current flowing from the first reference voltage terminal n1″ to the signal pad 714, thereby enhancing the accuracy of the first reference voltage level Vcc1″.

Implementing the P-type field effect transistor and the N-type field effect transistor respectively as the first electrostatic protection device 702 and the second electrostatic protection device 708 is also not a limitation of this embodiment. According to another embodiment of the present invention, the first electrostatic protection device 702 and the second electrostatic protection device 708 can be implemented by diodes, as shown in FIG. 4. As a person skilled in the art can readily understand the related operation of such an alternative design after reading the above paragraphs directed to technical features of the embodiment shown in FIG. 7, further description is omitted here for brevity.

Please note that, the above-mentioned electrostatic discharge protection circuits 500, 600 and 700 illustrated using the high voltage process are for illustrative purposes only, and are not meant to be limitations of the present invention. Furthermore, the electrostatic discharge protection circuit of the present invention is not limited to be implemented by a field effect transistor or a diode, and any electrostatic protection device structure which has the parasitic bipolar junction transistor formed therein should be considered within the scope of the present invention. In other words, the technical features disclosed by the present invention are applicable to any electrostatic discharge protection circuit fabricated by the semiconductor manufacturing process.

In summary, the clamping circuit disclosed by the present invention can reduce or remove the leakage current of the parasitic bipolar junction transistor of an electrostatic discharge protection circuit effectively. In this way, the accuracy of the reference voltage level connected to the electrostatic discharge protection circuit can be greatly enhanced.

Those skilled in the art will readily observe that numerous modifications and alterations of the device and method may be made while retaining the teachings of the invention.

What is claimed is:

1. An electrostatic discharge protection circuit, comprising:
an electrostatic protection device, coupled between a first reference voltage terminal and a signal pad, for protecting a circuit coupled to the signal pad;
a bipolar junction transistor has an emitter terminal coupled to the signal pad, a collector terminal coupled to a second reference voltage terminal, and a base terminal coupled to the first reference voltage terminal, wherein the bipolar junction transistor is a parasitic bipolar junction transistor of the electrostatic protection device; and
a clamping circuit, coupled to the bipolar junction transistor, for clamping a conductivity of the bipolar junction transistor according to a signal received at the signal pad.

2. The electrostatic discharge protection circuit of claim 1, wherein the clamping circuit is electrically connected between the emitter terminal of the bipolar junction transistor and the signal pad.

3. The electrostatic discharge protection circuit of claim 2, wherein the clamping circuit comprises a resistor device.

4. The electrostatic discharge protection circuit of claim 2, wherein when the signal pad receives the signal, the clamping circuit generates a voltage drop according to the signal, thereby reducing a current flowing through the emitter terminal of the bipolar junction transistor.

5. The electrostatic discharge protection circuit of claim 4, wherein the signal is not an electrostatic discharge signal.

6. The electrostatic discharge protection circuit of claim 1, wherein the clamping circuit is electrically connected between the base terminal of the bipolar junction transistor and the first reference voltage terminal.

7. The electrostatic discharge protection circuit of claim 6, wherein the clamping circuit comprises a resistor device.

8. The electrostatic discharge protection circuit of claim 6, wherein when the signal pad receives the signal, the clamping circuit generates a voltage drop according to the signal, thereby reducing a current flowing through the base terminal of the bipolar junction transistor.

9. The electrostatic discharge protection circuit of claim 8, wherein the signal is not an electrostatic discharge signal.

10. The electrostatic discharge protection circuit of claim 1, wherein the clamping circuit is electrically connected between the base terminal and the emitter terminal of the bipolar junction transistor.

11. The electrostatic discharge protection circuit of claim 10, wherein the clamping circuit comprises a schottky diode, an anode of the schottky diode is electrically connected to the emitter terminal of the bipolar junction transistor, and a cathode of the schottky diode is electrically connected to the base terminal of the bipolar junction transistor.

12. The electrostatic discharge protection circuit of claim 10, wherein when the signal pad receives the signal, the clamping circuit generates a voltage drop according to the signal, thereby stopping the bipolar junction transistor from being turned on.

13. The electrostatic discharge protection circuit of claim 1, wherein the electrostatic protection device is a field effect transistor.

14. The electrostatic discharge protection circuit of claim 1, wherein the electrostatic protection device is a diode.
